(19) United States
(12) Patent Application Publication
(10) Pub. No.: US 2024/0093833 A1
(43) Pub. Date: Mar. 21, 2024

(54) SYSTEM FOR UNDERWATER COMPRESSED GAS STORAGE

(71) Applicant: WestGen Energy, LLC, Santa Monica, CA (US)

(72) Inventor: Alexander Nadolishny, Santa Monica, CA (US)

(21) Appl. No.: 18/370,285

(22) Filed: Sep. 19, 2023

Related U.S. Application Data
(60) Provisional application No. 63/523,470, filed on Jun. 27, 2023.
(60) Provisional application No. 63/408,242, filed on Sep. 20, 2022.

(51) Int. Cl. F17C 1/00; F17C 5/06

(52) U.S. Cl. CPC F17C 1/007; F17C 5/06; F17C 2221/012; F17C 2227/0157; F17C 2227/0318; F17C 2270/0102

(57) ABSTRACT

A system for storing compressed gas that includes a surface structure, a gas storage assembly and a thermal storage assembly. The surface structure includes a compressor and expander assembly associated therewith. The gas storage assembly includes at least one gas receiver and is in fluid communication with the compressor and expander assembly. In use, the gas storage assembly is disposed in a body of water. The gas storage assembly is configured to move within the body of water from a first level to a second level when compressed gas is added to the gas storage assembly. The second level is deeper than the first level. The thermal storage assembly includes a tank containing water therein. The thermal storage assembly is in thermal communication with the compressor and expander assembly. The heat generated from the compression of the gas is transferred to the water in the tank in the thermal storage assembly.

### CROSS-REFERENCE TO RELATED APPLICATIONS

This application claims the benefit of U.S. Provisional Application No. 63/523,470, filed on Jun. 27, 2023, and U.S. Provisional Application No. 63/408,242, filed on Sep. 20, 2022, the entireties of which are incorporated by reference herein.

### FIELD OF THE INVENTION

The present invention relates to underwater storage of compressed gas, and more particularly to a system for dynamic use of hydrostatic pressure for high-pressure gas storage using low-pressure vessels.

### BACKGROUND OF THE INVENTION

Compressed gas storage has many applications ranging from commodity storage to energy storage. High pressures required for space-efficient storage often require expensive storage vessels. Additionally, storage of flammable gases (especially hydrogen) may pose a risk to the surrounding areas, thus creating challenges for large-scale storage near densely populated major urban centers.

When compressed air is used as an energy storage medium, the expense of conventional high-pressure tankage is cost-prohibitive and most CAES (compressed air energy storage) projects conceived to date rely on the use of underground caverns left from mining, severely limiting geographic areas where such facilities can be built. Underwater compressed air storage technologies typically rely on bottom-placed structures, leading to limitations with regards to the areas where such technology can be deployed (i.e., on relatively shallow sections of continental shelf and in shallow lakes), while requiring extremely expensive deep diving operations for construction and maintenance.

Hydrogen storage is a rapidly expanding field due to the increasing demand for “green” hydrogen, used as longer-term energy storage medium, as well as an alternative (low-carbon) fuel. However, placing large-volume H₂ storage near urban centers and critical infrastructure is met with high levels of public resistance due to safety concerns, which puts severe constraints on the transition of energy facilities and transportation to low-carbon fuels. Similar issues exist with storage of other gases that pose safety hazards.

The present invention includes a novel system for low-cost underwater compressed gas storage. The present invention is not limited to the storage of compressed air and hydrogen, and is applicable to storing any gaseous material.

The background description disclosed anywhere in this patent application includes information that may be useful in understanding the present invention. It is not an admission that any of the information provided herein is prior art or relevant to the presently claimed invention, or that any publication specifically or implicitly referenced is prior art.

### SUMMARY OF THE PREFERRED EMBODIMENTS

In accordance with a first aspect of the present invention, there is provided a system for storing compressed gas that includes a surface structure that includes a compressor and expander assembly associated therewith, a gas storage assembly, and a thermal storage assembly. The gas storage assembly includes at least one gas receiver and is in fluid communication with the compressor and expander assembly. The gas storage assembly is disposed in a body of water. The gas storage assembly is configured to move within the body of water from a first level to a second level when compressed gas is added to the gas storage assembly. The second level is deeper than the first level. The thermal storage assembly includes a tank containing water therein. The thermal storage assembly is in thermal communication with the compressor and expander assembly.

In accordance with another aspect of the present invention, there is provided a method of storing compressed gas using an underwater compressed gas storage system that includes a surface structure, a thermal storage assembly and a gas storage assembly that is located within a body of water at a first level. The method includes operating a compressor associated with the surface structure to compress gas to provide a compressed gas, and transferring the compressed gas to the gas storage assembly. After the compressed gas is transferred to the gas storage assembly the gas storage assembly moves to a second level within the body of water. The second level is deeper than the first level. The method also includes transferring heat that is generated during the gas compression step to a water storage tank associated with the thermal storage assembly.

The method may also include the step of transferring the compressed gas from the gas storage assembly and the heat from the thermal storage system to a gas expander assembly, and where the gas expander assembly expands the gas to a lower pressure to generate power. The gas storage assembly may include a flotation control device that is used to control the gas storage assembly during the transferring step as the gas storage assembly moves to the second level. The flotation control device may be used to move the gas storage assembly from the second level to a third level that is shallower than the second level. The thermal storage assembly may be submerged in the body of water. The thermal storage assembly may include a flotation control device.

In accordance with an aspect of the present invention, the present invention includes an underwater compressed gas storage system, wherein at least a portion of the system is floating in or disposed in a body of water. The system includes a surface platform, a gas compressor assembly mounted on or to the surface platform, a gas expander assembly mounted on or to the surface platform, a control system mounted on or to the surface platform, an electrical switchgear (optionally with step-up and step-down transformers), and a gas storage assembly for storing compressed gas. The gas storage assembly can be located at a plurality of positions, heights or depths within or with respect to the body of water and the surface thereof. Preferably, the gas storage assembly may be submerged in the body of water, but is not mounted on or to a bottom of the body of water. Preferably, the gas storage assembly includes an array of gas receivers and is in fluid communication with the gas compressor and gas expander assemblies. Preferably, the compressed gas storage system also includes a thermal storage system that includes water in a thermally insulated enclosure submerged in the body of water or the thermal transfer working fluid is in thermally insulated enclosures submerged in the body of water or mounted on the surface platform. Preferably, water is used as the thermal transfer fluid. However, this is not a limitation and other thermal transfer fluids may be used. Preferably, the thermal storage system is in thermal communication with the gas compressor and gas expander assemblies. It will be appreciated that the gas expander assembly may include a generator or a hydraulic brake connected thereto.

The air or gas storage assembly may include a flotation control device that allows the gas storage system to be positioned at a desired or predetermined depth or different depths at different times. The thermal storage system may include a flotation control device that allows the gas storage system to be positioned at a desired depth. In one preferred embodiment, the underwater compressed gas storage system may use air as a working fluid for use in conjunction with an off-shore wind electric generation facility and co-located with a floating wind turbine that is used on or as a surface structure or platform. In a preferred embodiment, the underwater compressed gas storage system may use air as a working fluid for use in conjunction with an off-shore wind electric generation facility and co-located with a floating substation that is used on or as a surface structure or platform. In another preferred embodiment, the underwater compressed gas storage system uses air as a working fluid for use with an off-shore wind electric generation facility and which uses a purpose-built surface structure or platform.

In another preferred embodiment, the underwater compressed gas storage system uses air or hydrogen as a working fluid for use in conjunction with a shore-based surface platform. For example, the platform may be on shore and the pipes, hoses, etc. may extend into the water where the air or gas is stored underwater, as is discussed with other embodiments described herein.

In a preferred embodiment, the underwater compressed gas storage system uses hydrogen as the working fluid and has the primary purpose of hydrogen storage, with or without electricity generation during hydrogen expansion. In a preferred embodiment, the underwater compressed gas storage system may use any gaseous substance as the working fluid and has the primary purpose of material or gas storage, with or without electricity generation during gas expansion. It will be appreciated that the thermal storage system can be omitted.

In a preferred embodiment, the present invention may be implemented in marine areas, inland lakes or any body of water of any depth, including over approximately 1,500 feet, and can be implemented either using purpose-built offshore structures or leveraging existing structures used with offshore wind facilities (e.g., wind turbines, floating substations) or re-purposed oil/gas drilling/production platforms (in all instances such platforms, new or re-purposed, may be referred to herein as a “surface platform”). Preferably, the present invention allows for a reduction of the complexity and cost of an energy storage solution (when compared to the prior art) coupled, and co-located with offshore wind turbines, standalone energy storage, or the cost of large-volume hydrogen storage. Preliminary estimates indicate that this system may cost less than an equivalent-capacity battery energy storage system or other compressed air energy storage systems, and may be less than existing large-volume compressed (non-liquefied) hydrogen storage system. Unlike battery energy storage, there is no capacity degradation with time, and therefore no need for expensive capacity augmentation. Unlike compressed hydrogen storage, there is no or greatly reduced fire and explosion hazard.

Estimates indicate that a 65-75% round trip efficiency may be possible with this technology in energy storage applications, thanks to advanced heat recovery and reuse and the resulting high thermodynamic efficiency. This feature also reduces parasitic energy demand for other gas storage applications.

In a preferred embodiment, the system is easily serviceable using surface operations, and for ongoing inspections without taking the system offline. For example, the system may be serviced using a combination of surface (above water) and shallow diving operations, preferably without the need for diver decompression. The system may not be affected by wave action in case of a storm. In a preferred embodiment, the modular design allows parts or portions of the system to be taken off-line while still maintaining at least a temporary partial-capacity operation (e.g., if service work is delayed due to limited access during a major weather event). In a preferred embodiment, some of the more expensive system components (e.g., compressors and turboexpander/generators) may be located above water in a protected enclosure that may be incorporated into the surface structure.

It will be appreciated that at least some of the key elements of the system include a compressed air storage system, a heat recovery and reuse system, multi-stage liquid-cooled air compressors, multi-stage turbo-expander generators, an advanced control system and electrical interconnection equipment.

The invention, together with additional features and advantages thereof, may be best understood by reference to the following description.

### BRIEF DESCRIPTION OF THE DRAWINGS

The invention may be more readily understood by referring to the accompanying drawings in which:

FIG. 1 is a schematic of an underwater compressed gas storage system that includes a windmill in accordance with a preferred embodiment of the present invention;

FIG. 2 is a schematic of an underwater compressed gas storage system in accordance with a preferred embodiment of the present invention; and

FIG. 3 is a flow chart associated with the underwater compressed gas storage system.

Like numerals refer to like parts throughout the several views of the drawings.

### DETAILED DESCRIPTION OF THE PREFERRED EMBODIMENTS

The following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be, but not necessarily are references to the same embodiment; and, such references mean at least one of the embodiments. If a component is not shown in a drawing then this provides support for a negative limitation in the claims stating that that component is “not” present. However, the above statement is not limiting and in another embodiment, the missing component can be included in a claimed embodiment.

Reference in this specification to “one embodiment,” “an embodiment,” “a preferred embodiment” or any other phrase mentioning the word “embodiment” means that a particular feature, structure, or characteristic described in connection with the embodiment is included in at least one embodiment of the-disclosure and also means that any particular feature, structure, or characteristic described in connection with one embodiment can be included in any embodiment or can be omitted or excluded from any embodiment. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others and may be omitted from any embodiment. Furthermore, any particular feature, structure, or characteristic described herein may be optional. Similarly, various requirements are described which may be requirements for some embodiments but not other embodiments. Where appropriate any of the features discussed herein in relation to one aspect or embodiment of the invention may be applied to another aspect or embodiment of the invention. Similarly, where appropriate any of the features discussed herein in relation to one aspect or embodiment of the invention may be optional with respect to and/or omitted from that aspect or embodiment of the invention or any other aspect or embodiment of the invention discussed or disclosed herein.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks: The use of highlighting has no influence on the scope and meaning of a term; the scope and meaning of a term is the same, in the same context, whether or not it is highlighted.

It will be appreciated that the same thing can be said in more than one way. Consequently, alternative language and synonyms may be used for any one or more of the terms discussed herein. No special significance is to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions, will control.

It will be appreciated that terms such as “front,” “back,” “top,” “bottom,” “side,” “short,” “long,” “up,” “down,” “aft,” “forward,” “inboard,” “outboard” and “below” used herein are merely for ease of description and refer to the orientation of the components as shown in the figures. It should be understood that any orientation of the components described herein is within the scope of the present invention.

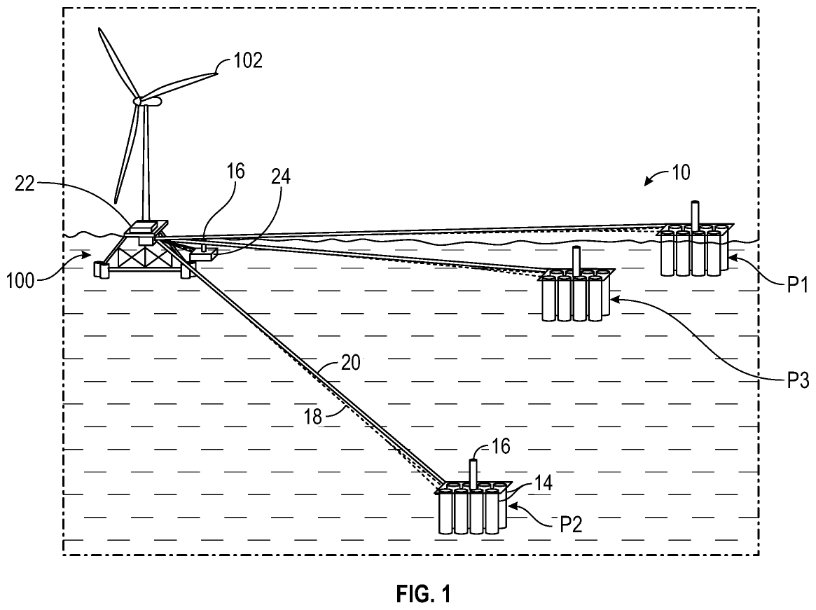

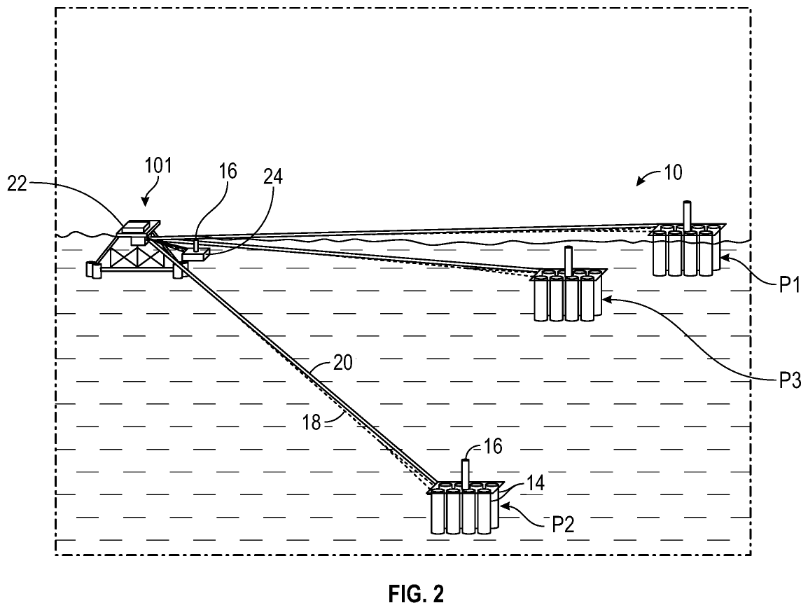

It will be appreciated that the present invention and system 10 may include or be utilized with offshore, floating wind platforms 100 that include one or more wind turbines 102, as is shown in FIG. 1. However, this is not a limitation on the present invention, and the inventive system may include or be utilized with any surface platform or surface structure 101, as shown in FIG. 2, and is not limited to compressed air storage (whether or not generated by a wind energy), but may be used for any compressed gas storage. The inventive system can be utilized in deep water where it is not feasible to mount or place any of the components on the bottom or floor of the body of water.

FIG. 1 shows the system including a surface platform that is embodied as a floating wind platform 100 that includes a windmill or wind turbine 102. FIG. 2 shows the system with the wind turbine omitted and includes a floating or surface mounted surface platform or surface structure 101 or assembly.

In a preferred embodiment, the system 10 includes a compressed air or gas storage system and a heat recovery and reuse system. The system preferably utilizes adiabatic compressed gas storage where air is compressed using energy while recovering the heat that is produced during the compression. When the gas is expanded out of the storage the heat that was previously recovered from the compression step or phase is used to reheat the gas. In the present invention, the pressure of the water column is used dynamically to compensate for the increased pressure in the holding tanks of the stored gas.

As shown in FIGS. 1 and 2, in a preferred embodiment, the system 10 includes a gas storage assembly 12 for compressed gas storage that includes an array of gas receivers 14 with any or all of a manifold, relief valves, pressure and temperature sensors, cathodic protection and a condensate control system. In the exemplary embodiment shown in FIGS. 1 and 2, the gas receivers 14 are 150 psi rated. However, this is only exemplary and any rating is within the scope of the present invention. It will be appreciated that all dimensions, measurements, ratings, pressures, depths and other numbers shown or discussed herein are only exemplary and not limiting. These dimensions, measurements, ratings, pressures, depths and other numbers may be changed or varied as necessary or in conjunction with one another. The gas storage assembly 12 allows air or other gas to be entered into the one or more tanks or gas receivers 14 and then removed therefrom, as desired.

The gas storage assembly 12 is shown in three different positions in FIGS. 1 and 2, the empty, service or first position, the charged, storage or second position, where the gas storage assembly 12 is shown deeper in the water, and the third position, where the gas storage assembly 12 is shallow, below the sea level water line and serviceable by shallow water diving operations. In the first position, the upper portion of the gas storage assembly 12 is above the water line so that certain portions, such as the manifold, valves and instrumentation can be serviced or otherwise accessed. The gas storage assembly 12 preferably includes a flotation control device 16 that can be utilized to change the depth of the gas storage assembly 12 or float the gas storage assembly 12 to or near the water line or surface. The flotation control device 16 can be inflated or deflated as necessary to move the gas storage assembly 12 to the desired position, depth or height within the body of water.

In a preferred embodiment, the gas storage assembly 12 is secured or attached to the surface platform 100 by a tether or tether system 18 (e.g., one or more cables, ropes or the like). A conduit or gas piping system 20 also extends between and provides gas or fluid communication between the floating wind platform 100 or surface structure 101 and the air or gas storage assembly 12. The gas piping system 20 may be rigid or semi-rigid depending on the specific needs in the area where the system 10 is deployed or as desired by the operator. In some embodiments, the tether system may be omitted. The system 10 also preferably includes a compressor, expander generator, switchgear and control enclosure (referred to herein generally as the compression and expansion assembly 22) that is interconnected with the electrical and control systems. The compressor, expander generator and other components may also be separate. However, in a preferred embodiment, these components are within or associated with the same structure or unit. The compression and expansion assembly 22 and the components therein may be located on the floating wind platform 100 or surface structure 101 at a position that they are above the water line or surface, as shown in FIGS. 1 and 2. In another embodiment, they may be located below the water line.

In a preferred embodiment, the system 10 also includes a thermal storage system 24 for hot water storage that includes a submerged, insulated thermal storage pool or enclosure that is filled with filtered seawater or water from the body of water (that may be pumped in to the thermal storage system). The thermal storage system 24 contains one or more heat exchangers for cooling of the compressor 30 from the cooling step or loop and heating of the expanding gas during the expander heating step or loop. The thermal storage system 24 preferably also includes a flotation control system (see, e.g., flotation control device 16) that keeps the thermal storage system 24 at a depth below wave action during normal use, but also allowing the thermal storage system 24 to be brought or raised to the surface for maintenance. The thermal storage system 24 may be tethered or otherwise connected or secured to or mounted on the floating wind platform 100. The thermal storage assembly or system 24 may also be located on the platform and/or above the surface of the water. However, due to the weight of the stored heated water, it may be advantageous to store the heated water in a submerged position (to limit the need for further structure to float the weight of the water on the platform. One or more water pipes, lines or conduits may extend between the compression and expansion assembly 22 and the thermal storage assembly to move or transfer heated water therebetween. The thermal storage assembly or system 24 may comprise one or multiple water storage pools containing both hot and cool water, as may be desired or required for optimizing system efficiency.

In use, the empty gas storage assembly may be in the first position or level (shown on the right or shallowest in FIGS. 1 and 2). In the second position or level (shown on the left or deepest in FIGS. 1 and 2), the gas storage assembly 12 is preferably fully charged or filled. It will be understood that the second position may change depending on how much compressed gas is stored in the gas storage assembly. The more air or gas that is sent to or pumped into the gas storage assembly 12 and the individual gas receivers, the more weight is added and the gas storage assembly 12 sinks. The flotation control device 16 compensates the pressure so that the gas storage assembly does not sink too fast and can maintain a preferable or predetermined level or depth within the water column or body of water. In the exemplary embodiments shown in FIGS. 1 and 2, the gas storage assembly 12 is shown at 500 m depth (with a tank pressure ˜900 psia, 150 psig). Max depth is maintained to prevent psig dropping below 100, in order to allow operation of the flotation control device 16.

The third position or level is shown in the middle in FIGS. 1 and 2. In this position, the gas storage assembly 12 is at, for example, 100 psig (or minimum expander cut-in pressure), which, in an exemplary embodiment, is the lowest pressure during a normal cycling. This position keeps the gas storage assembly 12 out of the wave action but allows easy access for inspection (bottom of the array of air receivers 14 is preferably less than 40′ deep). In a preferred embodiment, the array of gas receivers 14 includes multiple sub-arrays that can be isolated and disconnected. The disconnection or connection of a sub-array can be done via shallow diving operations when the gas storage assembly 12 is in the third position (or the first position), so that they can be brought to the surface and towed away for repair or replacement, while allowing the system to still use the remaining sub-arrays. The third position is generally a fully discharged or close to fully discharged position.

In a preferred embodiment, the gas storage assembly 12 is brought to the depth of the third position (as shown in the middle in FIGS. 1 and 2) via discharge of some of the compressed gas in the tanks and via the flotation control device 16, which stops the ascent at or near the surface at a pre-set or predetermined depth and automatically controls flotation based on depth and differential pressure.

In the service or first position, the manifold, valves, instrumentation and other components are preferably above water level so that they can be serviced from above water level. The gas storage assembly 12 may also be brought to the first position or maintenance position via the flotation control device 16.

In areas with a relatively constant current, as a result of the tether system 18, the gas storage assembly 12 will remain downstream of the current in a relatively stable position, no matter what level it is at. In areas with variable current direction, consideration may be given to preventing tether and gas piping damage. It will be appreciated that the figures show a single gas storage assembly 12, however, there may be more than one and any number of gas storage assemblies or systems tethered or otherwise connected to the platform is within the scope of the invention.

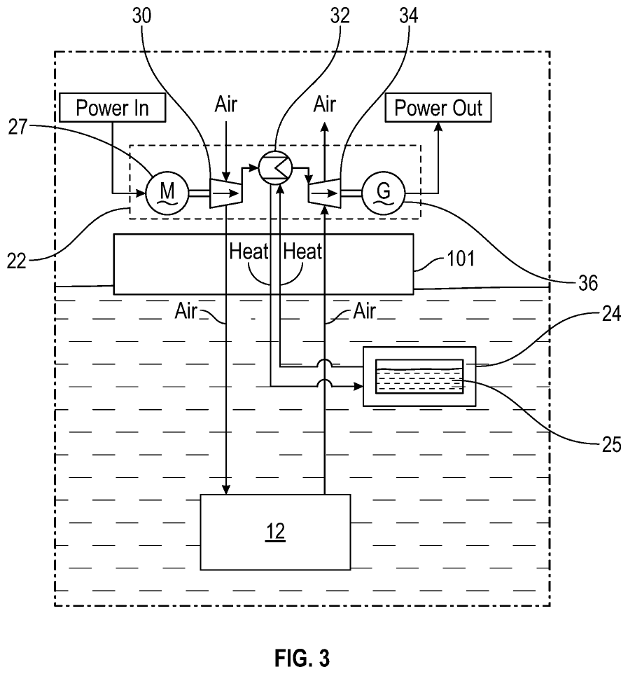

FIG. 3 shows a flow chart or schematic of at least a portion of the inventive system. With reference to FIGS. 1-3, in use, gas is compressed in the compressor 30 that is preferably part of the compressor and expander assembly 22 and the compressed gas is delivered to the gas storage assembly 12 or submersible array of gas tanks. As shown in FIG. 3, the gas may be air. However, this is not a limitation on the invention and any gas may be used. The compressor 30 may be powered by a motor 27. The motor may be powered by the power in or power source, which may be a wind turbine or any other source of power or energy. When the gas or air is compressed, heat is produced. The heat is transferred to the water pool or water tank 25 in the thermal storage assembly or system 24 or heat storage (this cools the compressor 30). As the gas storage assembly 12 is filled with the compressed gas, the gas storage assembly 12 moves to the second or storage position (the deepest position). The flotation control device 16 may be used to control the descent of the gas storage assembly 12 to the predetermined or desired depth. The gas storage assembly 12 is maintained at the predetermined depth of the storage position based on the density/amount of compressed gas and the flotation control device. It will be appreciated that there may be electrical and data communication between the components, assemblies or systems of the surface structure 101 (e.g., compressor and expander assembly 22), the gas storage assembly 12 (including the flotation control device 16), the thermal storage assembly or system 24 and/or any of the other components of the system.

At a point where it is desired to expand the gas, get power or electricity out of the system 10, a valve is switched and the compressed gas in the gas storage assembly 12 is expanded and electricity is ultimately generated. In another embodiment, separate conduits may be used to feed or transfer gas from the compressor 30 to the gas storage assembly 12 and from the gas storage assembly 12 to the gas expander assembly 34. As the gas is removed from the gas storage assembly 12 and expanded via a gas expander assembly 34 (e.g., an expander generator, turbine, turboexpander or other device), the density of the gas in the gas storage assembly 12 decreases and the gas storage assembly 12 to rises from the second position and toward the surface or water line.

At the beginning of the expansion or power out step, the stored gas is cold due to the gas storage assembly 12 being in the deep cold water in the fully charged or second position. Furthermore, the compressed gas undergoing expansion is subject to further cooling due to Joule-Thomson effect. The cold gas is reheated via the heat contained in and that was previously captured by the thermal storage system 24 and the water therein. This may be done using the heat exchanger 32. Reheating of the expanding gas using heat recovered from the earlier compression process provides overall cycle efficiency by approaching the adiabatic cycle conditions. The hot gas goes through the heat exchanger 32 (where the heat from the heated water is transferred to the gas) before entering the gas expander assembly 34 and expands further, which recovers or generates energy via a generator 36 or the like. It will be appreciated that, in a preferred embodiment, the thermal storage system 24 or heat storage is submerged and floats underwater and the gas storage system 12 is also submerged, but is preferably not secured to, at or near the bottom of the body of water. It will be appreciated that the gas storage assembly 12 may rest on the bottom of the body of water, but it is not secured or connected to the bottom of the water so that it can change levels.

In an embodiment, the gas storage assembly 12 (and/or thermal storage assembly 24) may include a tether or some type of connection that secures the gas storage assembly 12 (and/or thermal storage assembly 24) to the bottom of the body of water. However, such a tether must allow the gas storage assembly 12 (and/or thermal storage assembly 24) to be able to change levels. The tether is just for safety purposes, while still allowing the assemblies to be raised, lowered or otherwise move dynamically within the body of water.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description of the Preferred Embodiments using the singular or plural number may also include the plural or singular number respectively. The word “or” in reference to a list of two or more items, covers all of the following interpretations of the word: any of the items in the list, all of the items in the list, and any combination of the items in the list.

The above-detailed description of embodiments of the disclosure is not intended to be exhaustive or to limit the teachings to the precise form disclosed above. While specific embodiments of and examples for the disclosure are described above for illustrative purposes, various equivalent modifications are possible within the scope of the disclosure, as those skilled in the relevant art will recognize. Further, any specific numbers noted herein are only examples: alternative implementations may employ differing values, measurements or ranges.

Although the operations of any method(s) disclosed or described herein either explicitly or implicitly are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

The teachings of the disclosure provided herein can be applied to other systems, not necessarily the system described above. The elements and acts of the various embodiments described above can be combined to provide further embodiments. Any measurements or dimensions described or used herein are merely exemplary and not a limitation on the present invention. Other measurements or dimensions are within the scope of the invention.

Any patents and applications and other references noted above, including any that may be listed in accompanying filing papers, are incorporated herein by reference in their entirety. Aspects of the disclosure can be modified, if necessary, to employ the systems, functions, and concepts of the various references described above to provide yet further embodiments of the disclosure.

These and other changes can be made to the disclosure in light of the above Detailed Description of the Preferred Embodiments. While the above description describes certain embodiments of the disclosure, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features or aspects of the disclosure with which that terminology is associated. In general, the terms used in the following claims should not be construed to limit the disclosures to the specific embodiments disclosed in the specification unless the above Detailed Description of the Preferred Embodiments section explicitly defines such terms. Accordingly, the actual scope of the disclosure encompasses not only the disclosed embodiments, but also all equivalent ways of practicing or implementing the disclosure under the claims.

While certain aspects of the disclosure are presented below in certain claim forms, the inventors contemplate the various aspects of the disclosure in any number of claim forms. For example, while only one aspect of the disclosure is recited as a means-plus-function claim under 35 U.S.C. § 112, ¶6, other aspects may likewise be embodied as a means-plus-function claim, or in other forms, such as being embodied in a computer-readable medium. (Any claims intended to be treated under 35 U.S.C. § 112, ¶6 will include the words “means for”). Accordingly, the applicant reserves the right to add additional claims after filing the application to pursue such additional claim forms for other aspects of the disclosure.

Accordingly, although exemplary embodiments of the invention have been shown and described, it is to be understood that all the terms used herein are descriptive rather than limiting, and that many changes, modifications, and substitutions may be made by one having ordinary skill in the art without departing from the spirit and scope of the invention.

What is claimed is:

1. A system for storing compressed gas, the system comprising:
a surface structure that includes a compressor and expander assembly associated therewith,
a gas storage assembly, wherein the gas storage assembly includes at least one gas receiver and is in fluid communication with the compressor and expander assembly, wherein the gas storage assembly is disposed in a body of water, wherein the gas storage assembly is configured to move within the body of water from a first level to a second level when compressed gas is added to the gas storage assembly, wherein the second level is deeper than the first level, and
a thermal storage assembly that includes a tank containing water therein, wherein the thermal storage assembly is in thermal communication with the compressor and expander assembly.

2. The system of claim 1 wherein the surface structure is disposed in the body of water, and wherein the compressor and expander assembly is secured on, mounted to or otherwise associated with the surface structure.

3. The system of claim 2 further comprising a tether extending between the surface structure and the gas storage assembly.

4. The system of claim 1 wherein the compressor and expander assembly includes a compressor, a heat exchanger and a gas expander assembly.

5. The system of claim 1 wherein the gas storage assembly includes a flotation control device.

6. The system of claim 1 wherein the thermal storage system includes a flotation control device.

7. The system of claim 1 wherein the compressor and expander assembly includes a compressor, and wherein the compressor is powered by a wind turbine disposed on the surface structure.

8. The system of claim 1 wherein the gas storage assembly is configured to store compressed hydrogen.

9. A system for storing compressed gas, the system comprising:
a surface structure disposed in a body of water, wherein the surface structure includes a compressor and expander assembly associated therewith, wherein the compressor and expander assembly includes a compressor, a heat exchanger and a gas expander assembly, and wherein the compressor and expander assembly is secured on, mounted to or otherwise associated with the surface structure,
a gas storage assembly, wherein the gas storage assembly includes at least one gas receiver and is in fluid communication with the compressor and expander assembly, wherein the gas storage assembly is disposed in the body of water, wherein the gas storage assembly is configured to move within the body of water from a first level to a second level when compressed gas is added to the gas storage assembly, wherein the second level is deeper than the first level,
a thermal storage assembly that includes one or more tanks containing water therein, wherein the thermal storage assembly is in thermal communication with the compressor and expander assembly, and
a tether extending between the surface structure and the gas storage assembly.

10. The system of claim 9 wherein the gas storage assembly includes a flotation control device, and wherein the thermal storage system includes a flotation control device.

11. The system of claim 10 wherein the compressor is powered by electricity generated by a wind turbine disposed on the surface structure.

12. A method of storing compressed gas using an underwater compressed gas storage system that includes a surface structure, a thermal storage assembly and a gas storage assembly that is located within a body of water at a first level, the method comprising the steps of:
(a) operating a compressor associated with the surface structure to compress gas to provide a compressed gas,
(b) transferring the compressed gas to the gas storage assembly, wherein after the compressed gas is transferred to the gas storage assembly the gas storage assembly moves to a second level within the body of water, wherein the second level is deeper than the first level, and
(c) transferring heat that is generated during step (a) to a water storage tank associated with the thermal storage assembly.

13. The method of claim 12 further comprising the step of transferring the compressed gas from the gas storage assembly and the heat from the thermal storage system to a gas expander assembly, wherein the gas expander assembly expands the gas to a lower pressure to generate power.

14. The method of claim 12 wherein the gas storage assembly includes a flotation control device, wherein the flotation control device is used to control the gas storage assembly during step (b) as the gas storage assembly moves to the second level.

15. The method of claim 14 wherein the flotation control device is used to move the gas storage assembly from the second level to a third level that is shallower than the second level.

16. The method of claim 12 wherein the thermal storage assembly is submerged in the body of water.

17. The method of claim 16 wherein the thermal storage assembly includes a flotation control device.
